(19) United States
(12) Patent Application Publication
(10) Pub. No.: US 2011/0176952 A1
(43) Pub. Date: Jul. 21, 2011

(54) BINDER FOR THE PRODUCTION OF SINTERED MOLDED ARTICLES

(75) Inventors: Vladislav Kruzhanov, Remscheid (DE); Lars Wimbert, Schwelm (DE); Nicola De Cristofaro, Remscheid (DE)

(73) Assignee: GKN SINTER METALS HOLDING GMBH, Radevormwald (DE)

(21) Appl. No.: 13/026,522

(22) Filed: Feb. 14, 2011

Related U.S. Application Data
(63) Continuation of application No. PCT/EP2009/005925, filed on Aug. 14, 2009.

(30) Foreign Application Priority Data
Aug. 18, 2008 (DE) 10 2008 038 231.0

(51) Int. Cl. B22F 1/00; C04B 24/00; C22C 1/04

(52) U.S. Cl. 419/45; 106/285; 75/252

(57) ABSTRACT

The aim of the invention is to devise a binder that is an alternative to prior art binders for producing sintered molded articles. Said aim is achieved by a binder comprising a first substance that has a first melting point and a first vapor pressure at 80° C. and a second substance that has a second melting point and a second vapor pressure at 80° C., the maximum melting point of the first and second substance amounting to about 150° C., and the minimum vapor pressure of the first and second substance amounting to about 5 torr (667 Pa) at 80° C.

### CROSS-REFERENCE TO RELATED APPLICATIONS

This application is a continuation of International Application No. PCT/EP2009/005925 filed Aug. 14, 2009 which claims the benefit of German Application No. 10 2008 038 231.0 filed Aug. 18, 2008.

### TECHNICAL FIELD

The present invention relates to a binder for the production of sintered molded articles, and also to a mixture for the production of sintered molded articles comprising such a binder and to a method for the production of a mixture for the production of sintered molded articles and to a method for the production of sintered molded articles.

### BACKGROUND OF THE INVENTION

For the production of sintered molded articles, whether in typical pressing methods or else by means of injection molding or extrusion molding, it is necessary to use binders, so that a dimensionally accurate green compact can be produced from a powder mixture. This green compact is then subsequently sintered. Here, the powders could be plastic, ceramic, or metallic powders, wherein the powders themselves could also be mixtures of different plastics, ceramic materials, and/or metals or alloys or else powder processed in some other way, for example, coated powder. Here, in the case of metal powders, both pure metal powders, for example, iron powders, or else also powder mixtures, prealloyed powders, alloyed powders, or else also coated powders, also in mixtures of different powders with each other, could be used.

After the production of a green compact, the binders that are used must be removed. This can take place, for example, thermally before the sintering step, but a catalytic removal could also be provided, or else through the use of solvents, wherein the binders are dissolved and removed from the green compact. A disadvantage in this known method is, on one hand, the use of higher temperatures and/or additional substances, so that debinding, as the removal of the binder from green compacts is also called, is negatively affected in one way or the other, whether such that the costs increase due to the use of additional substances or due to the application of higher temperatures, or whether such that articles that are not sufficiently dense can be realized.

For example, DE 43 14 694 C1 discloses a method for the production of sintered molded articles through the deformation of a mixture made from a sinterable ceramic or metallic powder and polyoxymethylene or a copolymer with predominant portions of oxymethylene units as a binder to form a green body, removal of the binder catalytically with acid, in which, for removal of the binder, an acid is used that is solid at room temperature and sublimates or melts and evaporates at higher temperatures. The method described there thus comprises a debinding step in which an additional means, namely here an acid, is used.

The aim of the present invention is therefore to disclose a binder and also sinterable mixtures and a method for the production of such mixtures and also for the production of sintered molded articles by means of which the disadvantages known from the prior art are avoided.

To achieve this aim, according to the invention a binder for the production of sintered molded articles is proposed, comprising

a) a first substance with a first melting point and a first vapor pressure at 80° C.,

b) a second substance with a second melting point and a second vapor pressure at 80° C.,

wherein the melting points of the first and second substances equal a maximum of approximately 150° C. and the vapor pressures of the first and second substances equal at least approximately 5 Torr (667 Pa) at 80° C. Preferably, the first and the second vapor pressures differ from each other by a maximum of approximately 60%. Advantageously, here the first and the second vapor pressures of the first and the second substances are different, but they could also be identical. Advantageously, the first vapor pressure and the second vapor pressure of the first substance and the second substance lie at a maximum of approximately 100 Torr (13332 Pa=133.32 hPa=13.32 kPa), thus accordingly at approximately 13 kPa, wherein further preferred the first and second vapor pressures of the first and second substances lie in a range from approximately 5 Torr (667 Pa), preferably approximately 8 Torr (1067 Pa) to approximately 70 Torr (9333 Pa), each with respect to 80° C. The vapor pressure can here be determined according to the general formula:

log₁₀p=−A/T+B,

where p is the vapor pressure in Torr (1 Torr=133.3 Pa), A is a constant, in K, that can be taken from numerical methods, T is the temperature in K, and B is a constant in Torr. The conversion from Torr into Pascal here must be performed after the determination of the vapor pressure with units of Torr The logarithm in the above formula is a decadic logarithm. The constants A and B can be taken from numerical sets of calculations, for example, Landolt-Börnstein, Numerical Data and Functional Relationships From Physics, Chemistry, Astronomy, Geophysics, and Engineering, 6th edition, Springer Verlag Berlin Göttingen Heidelberg, 1960, Vol. II, 2nd part, pp. 89ff. (Example: for naphthalene, A=3616 and B=11.109 at 1 Torr (133 Pa); for 1,2,4,5-tetramethylbenzene, A=2313 and B=8.281 at 1 Torr (133 Pa)). Here, 0° C. corresponds to 273.15 K. The vapor pressure can be measured and determined, for example, according to the ASTM E 1194 or ASTM E 1782 standards.

Surprisingly, it has been shown that through the use of two substances with a low melting point in the binder according to the invention and especially a difference of the first and second vapor pressures of the first and second substances from each other by a maximum of approximately 60%, for the use of the binder according to the invention in sinterable mixtures, these exhibit good flowability, and the green compact obtained after the pressing exhibits high dimensional stability and also high green density. The first and second substances also act as pore-forming materials. Especially preferred here is the use of the binder according to the invention in a method using metal injection molding or metal extrusion molding. Work can then be performed with the screw of the extruder being used having temperatures of no more than approximately 100° C., preferably no more than approximately 90° C., compared with the otherwise typical high temperatures of the screw in the extruder being used of typically in a range from approximately 150 to approximately 180° C.

In the sense of the present invention, the term “approximately” is understood to the extent that, especially in connection with the melting point and the vapor pressure of the first and/or second substance, but also in connection with the other numerical parameters, deviations from the specified values of +−3%, preferably +−2%, further preferred +−1%, are possible, without endangering the success attained with the present invention. Also, outside of the ranges mentioned above, as long as the selected parameters do not lie far outside of these ranges, the success of the present invention can be achieved at least partially.

The first and second substances of the binder according to the invention are here advantageously selected from a group comprising organic substances, further preferred comprising organic substances with a molar mass of less than approximately 300 g/mol. In an especially preferred way, the first and second substances are selected from a group comprising cyclic hydrocarbons, aromatic hydrocarbons, and/or halogenated hydrocarbons, wherein the halogenated hydrocarbons can be partially, but also optionally completely halogenated. Here, in an especially preferred way, the first and/or second substances are selected from a group comprising camphene, tetramethylbenzene, in particular, 1,2,4,5-tetramethylbenzene, naphthalene, or carbon tetrabromide, or their derivatives. In the sense of the present invention, derivatives are understood to be substances that have, instead of substituents such as hydrogen, methyl, or bromine, other substituents such as, for example, fluorine, chlorine, or ethylene, or else the same substituents at a different position (e.g., 1,2,4,5-tetramethylbenzene and 1,2,3,5-tetramethylbenzene). However, substituents that are different than those mentioned are also conceivable. In an especially preferred way, naphthalene is selected as the first substance. In an especially preferred way, 1,2,4,5-tetramethylbenzene is selected as the second substance. However, other binder systems with first and second substances and the specifically claimed parameters are also possible, for example, a system made from 1,2,4,5-tetramethylbenzene and carbon tetrabromide as the first and/or second substance.

In an especially preferred way, the melting points of the first and second substances lie at a maximum of approximately 100° C., further preferred at a maximum of approximately 90° C. In a further preferred way, the melting points of the first and the second substances lie in a range from approximately 30° C., preferably approximately 50° C., to approximately 85° C. In another preferred embodiment, the first and the second vapor pressures of the first and second substances differ from each other by a maximum of approximately 50%. In another preferred embodiment of the present invention, the first and second vapor pressures of the first and second substances lie at a maximum of approximately 60 Torr (7999 Pa=7.999 kPa) at 80° C.

The binder according to the invention can here also comprise additional substances that guarantee, as additives, processability of the binder, for example, those that increase the storage stability. It could also be provided, however, that the binder comprises three or more substances acting as binders, wherein then their respective melting points each equal a maximum of approximately 150° C. and the vapor pressures of these differ from each other by a maximum of approximately 60%. For example, mixtures from naphthalene, 1,2,4,5-tetramethylbenzene and carbon tetrabromide could also be included by the binder according to the invention.

The present invention further relates to a mixture for the production of sintered molded articles, comprising

a) at least one sinterable material, and

b) a binder according to the invention as described above.

The materials described above in the present invention can be used as sinterable material. Someone skilled in the art will here select, on the basis of his or her expert knowledge, those materials that are suitable for the production method being used for the production of molded articles and the molded articles themselves. Here, the use of metallic powders, in particular, iron-containing powder, is especially preferred, wherein pure iron powder or powder from iron alloys or else mixtures from these materials could also be preferably used. Example sinterable materials that could be used are, for example, chrome-nickel-steel, bronzes, nickel-based alloys, such as Hastelloy, Inconel, metal oxides, metal nitrides, silicides, or the like, furthermore aluminum-containing powder or mixtures, wherein the mixtures can contain high-melting-point components, such as, for example, platinum or the like. The powders being used and their particle sizes are dependent on the respective purpose of use. Preferred iron-containing powders are the alloys 316 L, 304 L, Inconel 600, Inconel 625, Monel, and Hastelloy B, X, and C, as well as 17-4 PH. Titanium and/or titanium alloys are also suitable as materials, also in mixtures with other materials, in particular, iron-containing powders.

In a further preferred way, the mixture according to the invention for the production of sintered molded articles further comprises at least one stabilizer and/or at least one anti-agglomeration agent. The stabilizer is here advantageously selected from a group comprising plastic materials, especially preferred a group comprising polyethylene, polypropylenes, polyvinyl alcohols, polyvinyl acetate, polystyrene, and/or polyoxymethylene. In an especially preferred way, the stabilizer is a polyethylene or a mixture of different polyethylene materials. The stabilizer is here used primarily to guarantee sufficient residual stability of a component that has undergone at least partial debinding, in particular, a component in which the first and/or second substance has already been removed. The anti-agglomeration agent is advantageously selected from a group comprising organic acids; in a further preferred way, stearic acid is included as an anti-agglomeration agent by the mixture according to the invention.

Advantageously, the binder according to the invention is contained in the mixture according to the invention in a quantity of approximately 5 wt. % to approximately 12 wt. %, further preferred in a quantity of approximately 6 wt. % to approximately 9 wt. % with respect to the total quantity of the mixture. The stabilizer is advantageously contained in the mixture according to the invention in a quantity of approximately 1 wt. % to approximately 6 wt. %, further preferred approximately 2 wt. % to approximately 4.5 wt. %, each with respect to the total quantity of the mixture. The anti-agglomeration agent is advantageously contained in the mixture in a quantity of approximately 0.1 wt. % to approximately 1.3 wt. %, further preferred in a quantity of approximately 0.25 wt. % to approximately 0.7 wt. % each with respect to the total quantity of the mixture.

In the sense of the present invention, it can also be provided that the at least one anti-agglomeration agent and/or the at least one stabilizer is included by the binder according to the invention, so that a corresponding binder mixture in a prepared dosage form can be added to a sinterable material.

The present invention further relates to a method for the production of a mixture for the production of sintered molded articles, wherein at least one sinterable material is provided and this is mixed with the binder. In a further preferred way, the sinterable material is mixed with at least one anti-agglomeration agent before the mixture with the binder. In a further preferred way, the at least one anti-agglomeration agent is dissolved in a solvent, wherein this solution is preferably mixed with the at least one sinterable material. In another preferred embodiment, a mixture made from the dissolved anti-agglomeration agent and sinterable material is dried before addition of the binder. As the solvent for the anti-agglomeration agent or the mixture of the anti-agglomeration agent, advantageously alcohols, preferably ethanol, are used. The dissolving of the anti-agglomeration agent in a solvent is here performed advantageously at an elevated temperature, preferably at a temperature in a range of approximately 20° C., preferably approximately 50° C. to approximately 70° C. The drying of the mixture made from anti-agglomeration agent and sinterable material is advantageously performed at a temperature in a range of approximately 40° C. to approximately 80° C.

In the method according to the invention for the production of a mixture for the production of sintered molded articles, it is preferably provided that at least one stabilizer is added together with the binder or after the addition of the binder. Here it is preferred that the at least one stabilizer is included by the binder, so that, in one step, this binder mixture is added to sinterable material, preferably to sinterable material that is already mixed with the at least one anti-agglomeration agent.

After the addition of the binder or the binder mixture, the mixture (also called feedstock) is advantageously extruded and thus can be stored. The molded article to be sintered is advantageously produced by means of injection molding or extrusion molding. A production in the typical pressing method, however, is also not to be excluded. Then a dimensionally stable green compact is obtained with the method named above.

Finally, the present invention further relates to a method for the production of sintered molded articles through the deformation of a mixture according to the invention for the production of sintered molded articles, comprising

a) at least one sinterable material, and

b) a binder according to the invention

and removal of the first and/or second substance of the at least one binder through heating.

Alternatively, a method for the production of sintered molded articles could be provided through the deformation of a mixture according to the invention for the production of sintered molded articles, comprising

a) at least one sinterable material, and

b) a binder according to the invention

and removal of the first and/or second substance of the at least one binder through the application of a pressure of less than approximately 50 Torr.

The two alternative methods named above could also be combined in the sense of the present invention, that is, both heating and also an application of low pressure at a pressure of less than 50 Torr (6666 Pa) could be provided. Furthermore, it could also be provided that, in a single debinding step, not only the first and/or second substance, but also simultaneously the stabilizer and/or agglomeration agent that can be added to the mixture according to the invention is removed, so that a later, additional debinding step is unnecessary. However, two or more debinding steps could also be performed, wherein, in a first binding step, the first substance can be removed and in a second binding step, the second substance of the at least one binder can be removed.

In exceptional cases, it could also be provided that not only one, but instead two or three binder mixtures according to the invention are used. However, the use of other binders known from the state of the art is also possible.

Advantageously, the removal of the at least one binder according to the invention (debinding) is performed at a temperature of a maximum up to approximately 150° C., further preferred at a temperature of a maximum up to approximately 120° C., even more preferred at a temperature of a maximum up to approximately 100° C., even more preferred at a temperature of a maximum up to approximately 90° C.

After the debinding of the resulting green compact, wherein, in an additional debinding step, other binders can also be removed at higher temperatures, or else also a catalytic removal or else a removal through dissolving of the additional binders being used is performed, the green compact is sintered. Here, a plurality of different technologies exist. For example, the temperature profiles being applied during sintering could be selected differently. Someone skilled in the art will here select temperature profiles for the sintering based on his or her expert knowledge of the sinterable materials that are being used and with respect to the desired properties of the sintered molded articles to be completed. After the sintering, an optionally required heat treatment, in particular, a homogenization annealing, can follow advantageously directly. Here, the heat treatment can be performed as a function of the chemical composition of the resulting article. As an alternative or addition to the heat treatment, the sintered article could also be chilled advantageously in water or else by means of gas shock cooling, starting from the sintering or homogenization annealing temperature. In addition, after sintering, additional surface compression is possible, in general: an introduction of internal compressive stress in surface areas through sandblasting or shot peening, rolling, or the like. Coatings could then also be deposited on the article produced by means of the method according to the invention.

Advantageously, a temperature of a deformation tool being used in the method according to the invention for the production of sintered molded articles equals a maximum of approximately 120° C., further preferred a maximum of approximately 100° C. If a metal spraying device is used as the deformation tool, for example, then the temperature of the screw or screw sections arranged in this device equals advantageously a maximum of approximately 100° C., further preferred a maximum of approximately 90° C. Here, different temperatures could obviously also be provided for different areas of the screw, wherein these could each equal a maximum of approximately 100° C., further preferred a maximum of approximately 90° C.

These and other advantages of the present invention will be explained in detail with reference to the following example.

First it should be stated that the features listed in the following example do not limit the subject matter of the present application. Instead, the features specified in the general description including the example could be combined with each other to form refinements. In particular, a limitation to metal injection molding or metal extrusion molding is neither provided nor desired, but instead other materials or other methods could also be used.

First, a mixture was produced for the production of sintered molded articles, wherein this mixture is also called feedstock by those skilled in the art, from 92 wt. % iron powder with a particle size of d₉₀<10 μm, d₅₀<5 μm, and d₁₀<2 μm, and each 2.4 wt. % naphthalene as the first substance of the binder and 2.4 wt. % 1,2,4,5-tetramethylbenzene as the second substance of the binder, as well as 2.8 wt. % polyethylene as stabilizer (polyethylene MY 00 from Ter Hell Plastic GmbH, Herne, Germany) and also 0.4 wt. % stearic acid. The weight percentages each relate to the total quantity of feedstock.

The feedstock was produced in that initially the stearic acid was mixed with 350 ml pure ethanol and was then heated in a closed container to a temperature in a range from approximately 55° C. to approximately 60° C. In this way, a solution of the stearic acid in ethanol was realized. This solution was then added to the iron powder and the resulting mixture was mixed in a typical mixing device. Then, possible supernatant fluid was separated and the resulting mixture made from iron powder and stearic acid was dried, for example, in a heating cabinet at approximately 60° C.

Then the dried mixture was kneaded in a conventional kneader at approximately 105° C. under the addition of polyethylene, tetramethylbenzene, and naphthalene, wherein the addition of the substances named above can be performed simultaneously or in succession in arbitrary order. Here, a feedstock was then finally obtained that could then be extruded and stored in a closable and sealed container.

Then, by means of the extruded feedstock, molded articles were produced in the form of a fork with a structural length of 3.3 cm through metal injection molding (MIM). Here, the screw temperature of the injection molding device is selected in a range from approximately 70 to approximately 100° C. Additional injection parameters were an injection pressure of 1000 bar, an injection time of one second, and a charged dwell pressure of 100 bar. The cooling time equaled between 10 seconds and approximately 30 seconds. The nozzle temperature of the injection device lay in a range from approximately 50° C. to approximately 150° C.

Through the metal injection molding, dimensionally stable green compacts are obtained that were initially heated, for example, in a heating cabinet to approximately 60° C. for 8 to 10 hours, wherein the binder mixture made from naphthalene and tetramethylbenzene was removed. A further processing step is not necessary, in particular, not the addition of a solvent for the binder or else a catalyst, for example, in the form of an inorganic acid, such as, nitric acid, as is known from the prior art. A separate removal of the anti-agglomeration agent or the pore-forming material before the sintering step is not necessary, but could be performed. It could also be that the removal of the anti-agglomeration takes place just through the heating of the green compact, that is, during the removal of the naphthalene and tetramethylbenzene. Advantageously, however, the removal of the anti-agglomeration agent and also the pore-forming material takes place in the sintering step.

After the debinding by the removal of the mixture made from tetramethylbenzene and naphthalene, the molded green compact was sintered in a furnace. Here, a belt furnace, a roller furnace, a walking-beam furnace, or another suitable furnace, e.g., a discontinuous furnace, could be used. Here, after placement of the molded green compact, the furnace was first heated for one hour up to 150° C., then the temperature of 150° C. was held for two hours, then the furnace was further heated up to approximately 460° C. over approximately two hours, then held at the temperature of approximately 460° C. for approximately two hours, whereupon heating up to approximately 1225° C. for approximately 2.5 hours and holding at this temperature for approximately one hour were performed. Then the now sintered molded article was cooled and removed from the furnace.

Thus, through the present invention, a binder and also a mixture for the production of sintered molded articles (feedstock) and also a method for the production of such a feedstock or a method for the production of sintered molded articles are proposed, representing an alternative to the method known from the prior art, and advantageously there are, in particular, cost savings, due to the use of only lower temperatures for the debinding, but also very dimensionally stable green compacts and high-density, sintered molded articles are obtainable.

What is claimed:

1. A binder for the production of sintered molded articles, comprising:
a) a first substance with a first melting point and a first vapor pressure at 80° C.,
b) a second substance with a second melting point and a second vapor pressure at 80° C.,
wherein the melting point of the first and second substances equal a maximum of approximately 150° C. and the vapor pressures of the first and second substances equal at least approximately 5 Torr (667 Pa) at 80° C.

2. The binder according to claim 1, wherein the first and second vapor pressures deviate from each other by a maximum of approximately 60%.

3. The binder according to claim 1, wherein the vapor pressures of the first and second substances are different.

4. The binder according to claim 1, wherein the first vapor pressure of the first substance and the second vapor pressure of the second substance equal a maximum of approximately 100 Torr (13332 Pa) at 80° C.

5. The binder according to claim 1, wherein the first and second substances are selected from a group comprising cyclic hydrocarbons, aromatic hydrocarbons, and/or halogenated hydrocarbons.

6. The binder according to claim 1, wherein the melting points of the first and second substances equal a maximum of approximately 100° C.

7. The binder according to claim 1, wherein the first substance is naphthalene.

8. The binder according to claim 1, wherein the second substance is 1,2,4,5-tetramethylbenzene.

9. A mixture for the production of sintered molded articles, comprising:
a) at least one sinterable material, and
b) at least one binder comprising:
a) a first substance with a first melting point and a first vapor pressure at 80° C.,
b) a second substance with a second melting point and a second vapor pressure at 80° C.,
wherein the melting point of the first and second substances equal a maximum of approximately 150° C. and the vapor pressures of the first and second substances equal at least approximately 5 Torr (667 Pa) at 80° C.

10. The mixture according to claim 9, further comprising at least one stabilizer and/or at least one anti-agglomeration agent.

11. The mixture according to claim 9, wherein the binder is contained in the mixture in a quantity of approximately 2 wt. % to approximately 8 wt. % with respect to the total quantity of the mixture.

12. A method for the production of a mixture according to claim 9, wherein the at least one sinterable material is mixed with the binder.

13. The method according to claim 12, wherein the sinterable material is mixed with at least one anti-agglomeration agent before mixing with the binder.

14. The method according to claim 13, wherein the at least one anti-agglomeration agent is dissolved in a solvent to form a solution and the solution is mixed with the at least one sinterable material.

15. The method according to claim 14, wherein the mixture consisting of the dissolved anti-agglomeration agent and sinterable material is dried before addition of the binder.

16. The method according to claim 12, wherein at least one stabilizer is added together with the binder or after the addition of the binder.

17. The method according to claim 12, wherein the mixture is extruded.

18. A method for the production of sintered molded articles through the deformation of a mixture according to claim 9 comprising removing the first and/or second substance of the at least one binder through heating.

19. A method for the production of sintered molded articles through the deformation of a mixture according to claim 9 comprising removing the first and/or second substance of the at least one binder through the application of a pressure of less than approximately 50 Torr (6666 Pa).

20. The method according to claim 18, wherein the removal of the at least one binder is performed at a temperature of a maximum of up to approximately 150° C.

21. The method according to claim 18, wherein following the removal of the binder, the resulting green compact is sintered.

22. The method according to claim 18, wherein the deformation is performed at a maximum temperature of approximately 120° C.
